(19) United States
(12) Patent Application Publication
(10) Pub. No.: US 2006/0258214 A1
(43) Pub. Date: Nov. 16, 2006

(54) Seal assembly for an exposure apparatus

(75) Inventor: Douglas C. Watson, Campbell, CA (US)

Correspondence Address: THE LAW OFFICE OF STEVEN G ROEDER, 5560 CHELSEA AVE, LA JOLLA, CA, 92037, US

(73) Assignee: Nikon Corporation

(21) Appl. No.: 11/125,783

(22) Filed: May 10, 2005

(51) Int. Cl. H01R 13/40

(52) U.S. Cl. 439/587

(57) ABSTRACT

A seal assembly (44) for sealing a connector gap (274) between a connector (248) and a frame (258) includes a first subassembly (260) that seals the connector gap (274) and a second subassembly (262) that selectively seals the connector gap (274). With this design, the second subassembly (262) can seal the connector gap (274) in the event the first subassembly (260) fails and does not seal the connector gap (274). The second subassembly (262) can include a seal (382) that is movable between a first configuration (286) in which the seal (382) does not seal the connector gap (274) and a second configuration (288) in which the seal (382) does seal the connector gap (274).

### BACKGROUND

Exposure apparatuses are commonly used to transfer images from a reticle onto a semiconductor wafer during semiconductor processing. A typical exposure apparatus includes an illumination source, a reticle stage assembly that positions a reticle, an optical assembly, a wafer stage assembly that positions a semiconductor wafer, and a measurement system that precisely monitors the position of the reticle and the wafer.

The illumination source generates a beam of light energy that is directed at the reticle. The projection optical assembly directs and/or focuses the light from the reticle to the wafer. The reticle stage assembly includes a reticle stage and one or more motors to precisely position the reticle relative to the projection optical assembly. Similarly, the wafer stage assembly includes a wafer stage and one or more motors that precisely position the wafer relative to the projection optical assembly.

Depending upon the wavelength of the light energy generated by the illumination source, the type of fluid between the illumination source and the wafer can greatly influence the performance of the exposure apparatus. For example, some types of light energy are absorbed by oxygen and other gases. Absorption of the light energy can lead to losses of intensity and uniformity of the light energy. Accordingly, the performance of the exposure apparatus and the quality of the integrated circuits formed on the wafer can be enhanced by controlling the environment around one or both stages.

One way to control the environment around a stage includes positioning a chamber having one or more seals around the stage. Subsequently, the desired environment can be created within the chamber around the stage. Depending upon the type of controlled environment, it may take a significant amount of time to create the desired environment in the chamber. Unfortunately, one or more of the seals in the chamber can fail. In the event of seal failure, the desired environment in the chamber is compromised. Anytime the seal fails and the inside is exposed to the outside atmosphere, it will be necessary to reestablish the controlled environment again by purging, pump out, or other actions. This reduces the throughput of the exposure apparatus.

### SUMMARY

The present invention is directed to a seal assembly for sealing a connector gap between a connector and a frame. The seal assembly includes a first subassembly that seals the connector gap and a second subassembly that selectively seals the connector gap. With this design, the second subassembly can seal the connector gap in the event the first subassembly fails and does not seal the connector gap.

In one embodiment, the second subassembly includes a seal that is movable between a first configuration in which the seal does not seal the connector gap and a second configuration in which the seal does seal the connector gap. Additionally, the second subassembly can include a seal mover that moves the seal between the first configuration and the second configuration. In one embodiment, the seal mover directs a fluid into a seal cavity of the seal to move the seal from the first configuration to the second configuration. In another embodiment, the seal mover removes a fluid from the seal to move the seal from the second configuration to the first configuration.

In one embodiment, the first subassembly creates a fluid bearing in the connector gap that allows the connector to move relative to the frame. In one embodiment, the first subassembly creates a vacuum compatible fluid type bearing in the connector gap that allows the connector to move relative to the frame.

The present invention is also directed to a chamber assembly that includes the seal assembly, a stage assembly that includes the chamber assembly, an exposure apparatus the includes the stage assembly, a wafer, a device, a method for controlling an environment in a gap, a method for making an exposure apparatus, a method for making a device, and a method for manufacturing a wafer.

### BRIEF DESCRIPTION OF THE DRAWINGS

FIG. 1 is a side illustration of an exposure apparatus, in partial cut-away, having features of the present invention;

FIG. 2A is a perspective view of a stage assembly having features of the present invention;

FIG. 2B is a cut-away view taken on line 2B-2B in FIG. 2A;

FIG. 2C is an enlarged view of a portion of a chamber assembly with a pair of seals in a first configuration;

FIG. 2D is an enlarged view of the portion of the chamber assembly of FIG. 2C with the seals in a second configuration;

FIG. 3A is a perspective view of a portion of one embodiment of the seal in the first configuration;

FIG. 3B is a perspective view of the seal of FIG. 3A in the second configuration;

FIG. 3C is a perspective view of a portion of another embodiment of the seal;

FIG. 3D is a perspective view of a portion of yet another embodiment of the seal;

FIG. 4 is a cut-away view of another embodiment of a stage assembly having features of the present invention;

FIG. 5 is a cut-away view of a portion of the stage assembly with a stage in a first position and in a second position;

FIG. 6A is a flow chart that outlines a process for manufacturing a device in accordance with the present invention; and

FIG. 6B is a flow chart that outlines device processing in more detail.

### DESCRIPTION

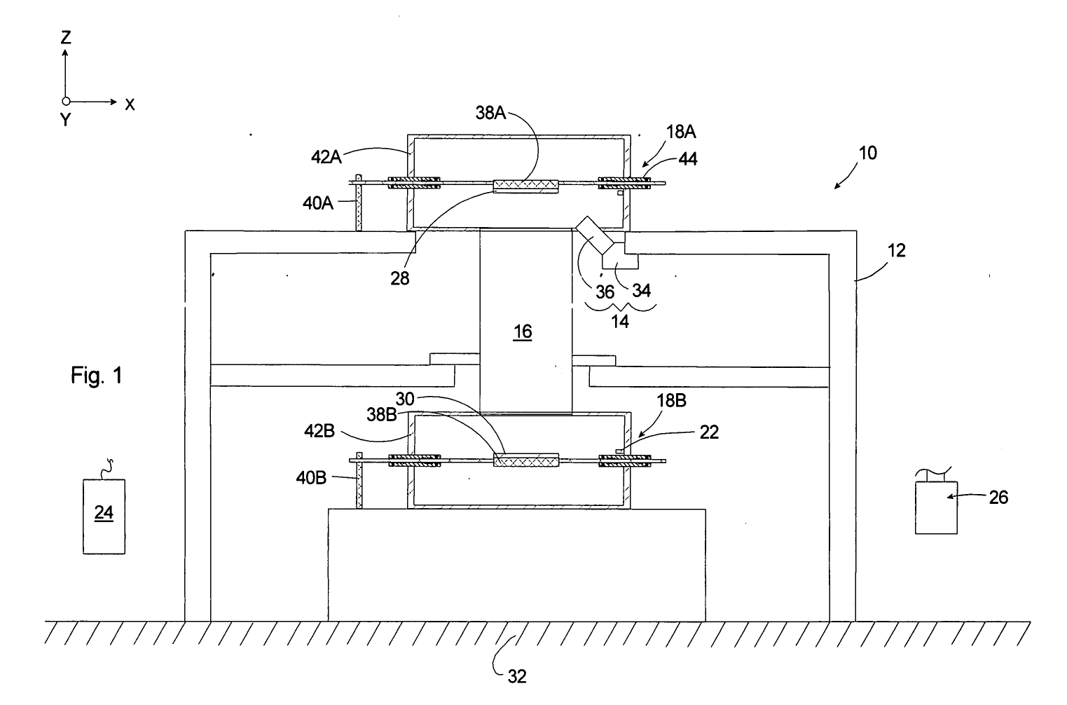

FIG. 1 is a schematic illustration of a precision assembly, namely an exposure apparatus 10 having features of the present invention. The exposure apparatus 10 includes an apparatus frame 12, an illumination system 14 (irradiation apparatus), an optical assembly 16, a first stage assembly 18A, a second stage assembly 18B, a measurement system 22, a control system 24, and an environmental system 26. The design of the components of the exposure apparatus 10 can be varied to suit the design requirements of the exposure apparatus 10.

A number of Figures include an orientation system that illustrates an X axis, a Y axis that is orthogonal to the X axis, and a Z axis that is orthogonal to the X and Y axes. It should be noted that these axes can also be referred to as the first, second and third axes.

In one embodiment, the exposure apparatus 10 is useful as a lithographic device that transfers a pattern (not shown) of an integrated circuit from a reticle 28 onto a semiconductor wafer 30 (illustrated in phantom). The reticle 28 and/or the wafer 30 are also referred to generally as a device. The exposure apparatus 10 mounts to a mounting base 32, e.g., the ground, a base, or floor or some other supporting structure.

There are a number of different types of lithographic devices. For example, the exposure apparatus 10 can be used as a scanning type photolithography system that exposes the pattern from the reticle 28 onto the wafer 30 with the reticle 28 and the wafer 30 moving synchronously. In a scanning type lithographic apparatus, the reticle 28 is moved perpendicularly to an optical axis of the optical assembly 16 by the reticle stage assembly 18A and the wafer 30 is moved perpendicularly to the optical axis of the optical assembly 16 by the wafer stage assembly 18B. Scanning of the reticle 28 and the wafer 30 occurs while the reticle 28 and the wafer 30 are moving synchronously.

Alternatively, the exposure apparatus 10 can be a step-and-repeat type photolithography system that exposes the reticle 28 while the reticle 28 and the wafer 30 are stationary. In the step and repeat process, the wafer 30 is in a constant position relative to the reticle 28 and the optical assembly 16 during the exposure of an individual field. Subsequently, between consecutive exposure steps, the wafer 30 is consecutively moved with the wafer stage assembly 18B perpendicularly to the optical axis of the optical assembly 16 so that the next field of the wafer 30 is brought into position relative to the optical assembly 16 and the reticle 28 for exposure. Following this process, the images on the reticle 28 are sequentially exposed onto the fields of the wafer 30, and then the next field of the wafer 30 is brought into position relative to the optical assembly 16 and the reticle 28.

However, the use of the exposure apparatus 10 provided herein is not limited to a photolithography system for semiconductor manufacturing. The exposure apparatus 10, for example, can be used as an LCD photolithography system that exposes a liquid crystal display device pattern onto a rectangular glass plate or a photolithography system for manufacturing a thin film magnetic head.

The apparatus frame 12 supports some of the components of the exposure apparatus 10. The apparatus frame 12 illustrated in FIG. 1 supports the reticle stage assembly 18A, the optical assembly 16 and the illumination system 14 above the mounting base 32.

The illumination system 14 includes an illumination source 34 and an illumination optical assembly 36. The illumination source 34 emits a beam (irradiation) of light energy. The illumination optical assembly 36 guides the beam of light energy from the illumination source 34 to the reticle 28. The beam illuminates selectively different portions of the reticle 28 and exposes the wafer 30. In FIG. 1, the illumination system 14 is illustrated as being supported below the reticle stage assembly 18. In this embodiment, the energy beam from the illumination system 14 is directed upwards towards the reticle 28 and reflected off the reticle 28 downward to the optical assembly 16. Alternatively, for example, the illumination system 14 can be positioned elsewhere.

The illumination source 34 can be a g-line source (436 nm), an i-line source (365 nm), a KrF excimer laser (248 nm), an ArF excimer laser (193 nm) or a F₂ laser (157 nm). Alternatively, the illumination source 34 can generate charged particle beams such as an x-ray or an electron beam. For instance, in the case where an electron beam is used, thermionic emission type lanthanum hexaboride (LaB₆) or tantalum (Ta) can be used as a cathode for an electron gun. Furthermore, in the case where an electron beam is used, the structure could be such that either a mask is used or a pattern can be directly formed on a substrate without the use of a mask.

The optical assembly 16 projects and/or focuses the light from the reticle 28 to the wafer 30. Depending upon the design of the exposure apparatus 10, the optical assembly 16 can magnify or reduce the image illuminated on the reticle 28. The optical assembly 16 need not be limited to a reduction system. It could also be a 1× or magnification system.

When far ultra-violet rays such as the excimer laser is used, glass materials such as quartz and fluorite that transmit far ultra-violet rays can be used in the optical assembly 16. When the F₂ type laser or x-ray is used, the optical assembly 16 can be either catadioptric or refractive (a reticle should also preferably be a reflective type), and when an electron beam is used, electron optics can consist of electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart U.S. patent application Ser. No. 873,605 (Application Date: Jun. 12, 1997) also use a reflecting-refracting type of optical system incorporating a concave mirror, etc., but without a beam splitter, and can also be employed with this invention. As far as is permitted, the disclosures in the above-mentioned U.S. patents, as well as the Japan patent applications published in the Official Gazette for Laid-Open Patent Applications are incorporated herein by reference.

The first stage assembly 18A holds and positions the reticle 28 relative to the optical assembly 16 and the wafer 30. In one embodiment, the first stage assembly 18A includes a first stage 38A that retains the reticle 28, a first stage mover assembly 40A that moves and positions the reticle stage 38A and reticle 28, and a first chamber assembly 42A that encircles and encloses the first stage 38A and the reticle 30.

The second stage assembly 18B holds and positions the wafer 30 with respect to the projected image of the illuminated portions of the reticle 28. In one embodiment, the second stage assembly 18B includes a second stage 38B that retains the wafer 30, a second stage mover assembly 40B that moves and positions the second stage 38B and the wafer 28 relative to the optical assembly 16, and a second chamber assembly 42B that encircles and encloses the second stage 40B and the wafer 28.

As an overview, one or both of the chamber assemblies 42A, 42B includes one or more seal assemblies 44 that facilitate a secure, controlled environment around the respective device. In the embodiment illustrated in FIG. 1, each of the chamber assemblies 42A, 42B includes a pair of spaced apart seal assemblies 44. Alternatively, for example, one or both of the chamber assemblies 42A, 42B can include only one or more than two seal assemblies 44. Further, one of the stage assemblies 18A, 18B can be designed without the respective chamber assembly 42A, 42B.

In photolithography systems, when linear motors (see U.S. Pat. Nos. 5,623,853 or 5,528,118) are used in the wafer stage assembly or the reticle stage assembly, the linear motors can be either an air levitation type employing air bearings or a magnetic levitation type using Lorentz force or reactance force. Additionally, the stage could move along a guide, or it could be a guideless type stage that uses no guide. As far as is permitted, the disclosures in U.S. Pat. Nos. 5,623,853 and 5,528,118 are incorporated herein by reference.

Alternatively, one of the stages could be driven by a planar motor, which drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage base and the other unit is mounted on the moving plane side of the stage.

Movement of the stages generates reaction forces that can affect performance of the photolithography system. Reaction forces generated by the wafer (substrate) stage motion can be mechanically transferred to the floor (ground) by use of a frame member as described in U.S. Pat. No. 5,528,100 and published Japanese Patent Application Disclosure No. 8-136475. Additionally, reaction forces generated by the reticle (mask) stage motion can be mechanically transferred to the floor (ground) by use of a frame member as described in U.S. Pat. No. 5,874,820 and published Japanese Patent Application Disclosure No. 8-330224. As far as is permitted, the disclosures in U.S. Pat. Nos. 5,528,100 and 5,874,820 and Japanese Patent Application Disclosure No. 8-330224 are incorporated herein by reference.

The measurement system 22 monitors movement of the reticle 28 and the wafer 30 relative to the optical assembly 16 or some other reference. With this information, the control system 24 can control the first stage assembly 18A to precisely position the reticle 28 and the second stage assembly 18B to precisely position the wafer 30. The design of the measurement system 22 can vary. For example, the measurement system 22 can utilize multiple laser interferometers, encoders, mirrors, and/or other measuring device.

The control system 24 is electrically connected to the measurement system 22 and the stage assemblies 18A, 18B. In one embodiment, the control system 24 receives information from the measurement system 22 and controls the stage mover assemblies 40A, 40B to precisely position the reticle 28 and the wafer 30. Additionally, the control system 24 can control the operation of the components of the environmental system 26. The control system 24 can include one or more processors and circuits.

The environmental system 26 controls the environment in one or both of the chamber assemblies 42A, 42B. The desired environment created and/or controlled in the chamber assemblies 42A, 42B by the environmental system 26 can be selected accordingly to the design of the rest of the components of the exposure apparatus 10, including the illumination system 14. For example, the desired controlled environment can be a vacuum type environment. In this embodiment, the environmental system 26 removes the fluid from the chamber assemblies 42A, 42B. Alternatively, for example, the controlled environment can be an inert gas, such as Argon, Helium, or Nitrogen, or another type of fluid. In this embodiment, the environmental system 26 fills the chamber assemblies 42A, 42B with the desired fluid.

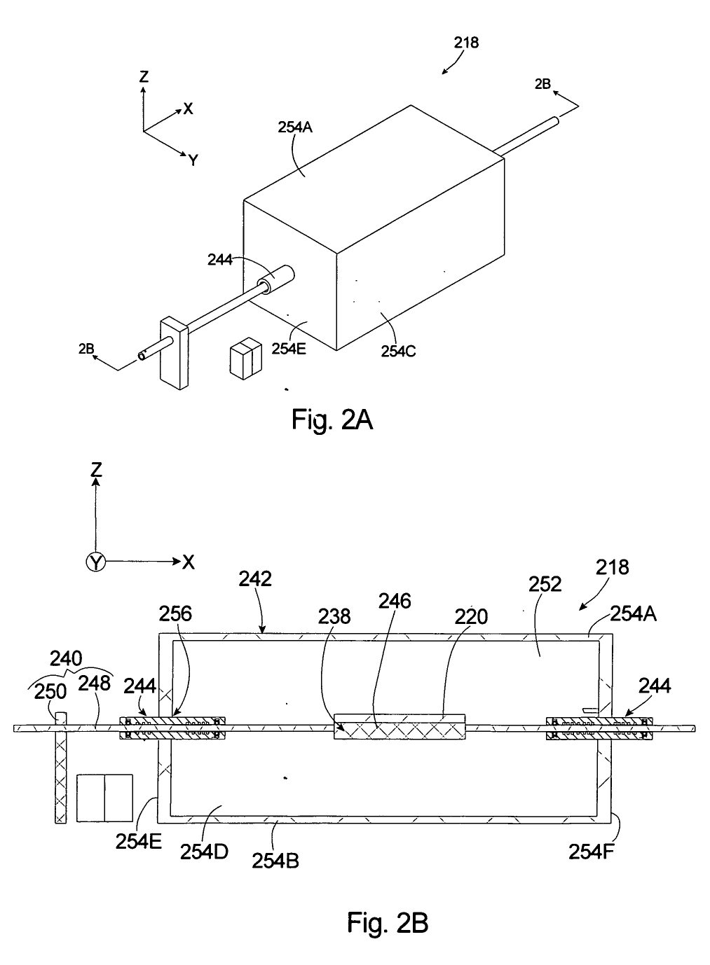

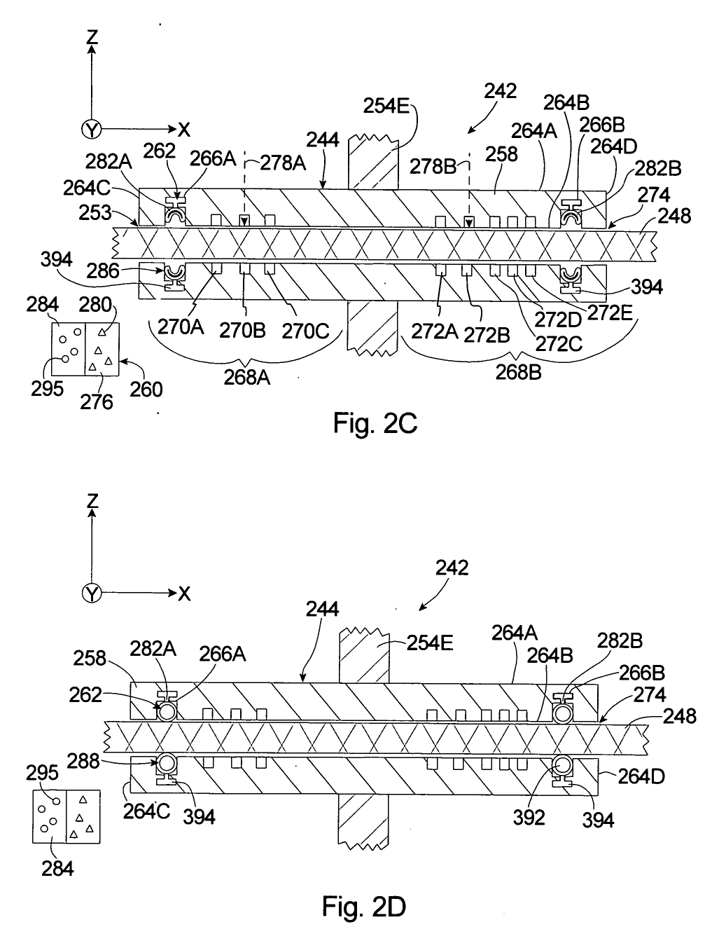

FIG. 2A is a perspective view of a first embodiment of a stage assembly 218 having features of the present invention. The stage assembly 218 can be used as the first stage assembly 18A or the second stage assembly 18B described above and illustrated in FIG. 1.

FIG. 2B illustrates a cut-away view of the stage assembly 218 of FIG. 2A. In this embodiment, the stage assembly 218 holds and positions a device 220. In one embodiment, the stage assembly 218 includes a stage 238, a stage mover assembly 240, and a chamber assembly 242 having a pair of spaced apart seal assemblies 244.

The stage 238 retains the device 220. In this embodiment, the stage 238 includes a generally rectangular shaped stage frame 246 and a device holder (not shown) that retains the device 220. The device holder can be a vacuum chuck, an electrostatic chuck, or some other type of clamp. In one embodiment, the device holder is movable relative to the stage frame 246 to make fine adjustments of the position of the device 220 relative to the stage frame 246.

The stage mover assembly 240 moves and positions the stage 238 and the device 220. In the embodiment illustrated in FIG. 2B, the stage mover assembly 240 includes a mover connector 248 and a mover assembly 250 (illustrated as a block). In the embodiment illustrated in FIG. 2B, the mover connector 248 is a rigid beam that extends transversely through the chamber assembly 242 including the seal assemblies 244. Further, the mover connector 248 is sealed to the rest of the chamber assembly 242 with the seal assemblies 244.

In FIG. 2B, the mover connector 248 has a circular shaped cross-section. Alternatively, for example, the mover connector 248 can have another shape, e.g. a rectangular or a hexagonal shaped cross-section. In one embodiment, the stage 238 is fixedly secured to the mover connector 248. Alternatively, for example, the stage mover assembly 240 could be designed to move the stage 238 relative to the mover connector 248.

The mover assembly 250 moves the mover connector 248 and the stage 238, and can include one or more movers, such as rotary motors, voice coil motors, linear motors utilizing a Lorentz force to generate drive force, electromagnetic movers, planar motors, or some other force movers. In alternative embodiments, the mover assembly 250 can move the stage 238 with one, two, three, four, five or six degrees of freedom. In the embodiment illustrated in FIG. 2B, the mover assembly 250 moves the mover connector 248 and the stage 238 along the X axis and about the X axis.

It should be noted that in this embodiment, the mover assembly 250 is positioned outside the chamber assembly 242. With this design, any dust and debris generated by the mover assembly 250 is outside the chamber assembly 242 and does not contaminate the controlled environment. Moreover, this design enhances the access to the components of the mover assembly 250 to allow for field servicing, maintaining, and trouble shooting. Further, the chamber assembly 242 can be made smaller than if the mover assembly 250 is positioned within the chamber assembly 242. The smaller chamber assembly 242 can facilitate faster pump-outs of the chamber assembly 242.

The chamber assembly 242 defines a device chamber 252 that encircles and encloses the stage 238 and the device 220. Further, the chamber assembly 242 is used in conjunction with the environmental system 26 (illustrated in FIG. 1) to provide the controlled environment around the device 220. The design of the components of the chamber assembly 242 can vary in size and shape according to the design of the exposure apparatus 10. In the embodiment illustrated in FIGS. 2A and 2B, the chamber assembly 242 is generally rectangular box shaped and includes (i) a top frame wall 254A, (ii) a bottom frame wall 254B that is spaced apart and substantially parallel with the top frame wall 244A, (iii) a front side frame wall 254C, (iv) a rear side frame wall 254D, (v) a left side frame wall 254E, (vi) a right side frame wall 254F, and (vii) a pair of spaced apart seal assemblies 244. The side frame walls 254C-254F extend perpendicularly to and between the top frame wall 254A and the bottom frame wall 254B. The use of the terms top, bottom, front, rear, left and right are used for convenience and the orientation of the chamber assembly 242 can be rotated.

In one embodiment, each of the frame walls 254A-254F is rigid and is constructed from materials such as metal or plastic. The required thickness and strength of the frame walls 254A-254F will depend upon type of controlled environment. For example, thicker and stronger frame walls 254A-254F are necessary if the controlled environment is a vacuum.

In FIG. 2B, the left side frame wall 254E and the right side frame wall 254F each include a wall aperture 256 for receiving one of the seal assemblies 244. Moreover, one or more of the frame walls 254A-254F can include one or more apertures for receiving a portion of the illumination system 14 (illustrated in FIG. 1), for receiving a portion of the optical assembly 16 (illustrated in FIG. 1), and/or for connecting the chamber assembly 242 in fluid communication with the environmental system 26 (illustrated in FIG. 1). One or more mechanical bellows (not shown) can be used to seal the illumination system 14 (illustrated in FIG. 1), and/or the optical assembly 16 to the one or more of the frame walls 254A-254F.

FIG. 2C illustrates a portion of the left side frame wall 254E, a portion of the mover connector 248, and the seal assembly 244 in more detail. In this embodiment, the seal assembly 244 includes a seal frame 258, a first subassembly 260 and a second subassembly 262.

The seal frame 258 is generally tubular ring shaped, defines a frame aperture 253 for receiving the mover connector 248, and includes an outer surface 264A, an inner surface 264B, a left side 264C, and a right side 264D. In this embodiment, the outer surface 264A is sealed to the left side frame wall 254E and the inner surface 264B is annular shaped. Further, in this embodiment, the seal frame 258 has a generally circular shaped cross-section. Alternatively, for example, the seal frame 258 can have a rectangular shaped cross-section, a hexagonal shape shaped cross-section or another shape that corresponds to the shape of the mover connector 248.

Further, in one embodiment, the inner surface 264B includes a first channel 266A positioned near the left side 264C, a second channel 266B positioned near the right side 264D, a first groove set 268A and a second groove set 268B. In this embodiment, each channel 266A, 266B is generally annular shaped and includes a somewhat rectangular shaped cross-sectional region and a “T” shaped cross-sectional region.

Further, in this embodiment, the first groove set 268A and the second groove set 268B are spaced apart and are positioned intermediate the first channel 266A and the second channel 266B. Further, moving sequentially from left to right, (i) the first groove set 268A includes a left first groove 270A, a left second groove 270B, and a left third groove 270C; and (ii) the second groove set 268B includes a right first groove 272A, a right second groove 272B, a right third groove 272C, a right fourth groove 272D, and a right fifth groove 272E. Alternatively, for example, one or both groove sets 268A, 268B can include more or fewer grooves.

In one embodiment, each groove 270A-272E is generally annular shaped. Alternatively, one or more of the grooves 270A-272E can be replaced with one or more radially disposed orifices or a porous region.

In one embodiment, the first subassembly 260 seals a connector gap 274 between the seal frame 258 and the mover connector 248, maintains the mover connector 248 a small distance away from the seal frame 258, allows the mover connector 248 to move relative to the seal frame 258 and the rest of the chamber assembly 242, and/or supports the mover connector 248 and the stage 238 (illustrated in FIG. 2B) relative to the seal frame 258 and the rest of the chamber assembly 242. In the embodiment illustrated in FIG. 2C, the first subassembly 260 allows the mover connector 248 to move relative to the seal frame 258 along the X axis and about the X axis. In one embodiment, the close proximity of the mover connector 248 and the seal frame 258 inhibits leakage via the connector gap 274.

The design of the first subassembly 260 can vary according to the design of the rest of the chamber assembly 242 and the controlled environment. In the embodiment illustrated in FIG. 2C, the first subassembly 260 includes a first fluid source 276 that creates a first seal/bearing 278A (illustrated as a dashed arrow) and a spaced apart second seal/bearing 278B (illustrated as a dashed arrow) between the seal frame 258 and the mover connector 248. In one embodiment, one or both of the seal/bearings 278A, 278B is a fluid type bearing. In this embodiment, one or both of the seal/bearings 278A, 278B can be a vacuum compatible fluid type bearing that is designed to minimize fluid that is released into the device chamber 252 and the surrounding environment.

In this embodiment, the grooves 270A-270C of the first groove set 268A are in fluid communication with the first fluid source 276. To create the first seal/bearing 278A, the first fluid source 276 forces a bearing fluid 280 (illustrated as triangles) from the left second groove 270B (the fluid outlet) of the first groove set 268A towards the mover connector 248 and removes the bearing fluid 280 from the other left grooves 270A, and 270C (the fluid inlets) of the first groove set 268A. In one embodiment, the left first groove 270A and the left third groove 270C are at a lower pressure than the left second groove 270B. In a non-exclusive embodiment, the pressure P1 at the left first groove 270A is the same as the pressure P3 at the left third groove 270C. For example, P1 and P3 can be equal to atmospheric pressure (1 atm).

Further, in this embodiment, the grooves 272A-272E of the second groove set 268B are in fluid communication with the first fluid source 276. To create the second seal/bearing 278B, the first fluid source 276 forces the bearing fluid 280 (illustrated as triangles) from the right second groove 272B (the fluid outlet) of the second groove set 268B towards the mover connector 248 and removes the bearing fluid 280 from the other grooves 272A, 272C, 272D, and 272E (the fluid inlets) of the second groove set 268B. In one embodiment, each successive fluid inlet to the right of the right second groove 272B, e.g. grooves 272C, 272D, and 272E from the fluid outlet, e.g. the right third groove 272C is connected to successively lower pressures in order to recover most of the bearing fluid 280 released from the right second groove 272B and minimize the bearing fluid 280 that reaches the device chamber 252. Stated another way, the first fluid source 276 controls the pressures in the grooves 272A, 272C, 272D, and 272E so that (i) pressure in the right first groove 272A is equal to P1, (ii) the pressure in the right third groove 272C is equal to P3, (iii) the pressure in the right fourth groove 272D is equal to P4, and (iv) the pressure in the right fifth groove 272E is equal to P5 and (v) P5<<P4<<P3.

In certain designs, the exact pressures utilized are not critical and can be controlled to minimize the leakage into the chamber assembly 242. In a non-exclusive embodiment, the pressure P1 at the right first groove 272A is the same as the pressure P3 at the right third groove 272C. For example, P1 and P3 can be equal to atmospheric pressure (1 atm).

In one embodiment, the left first groove 270A, the right first groove 272A, the left third groove 270C, and the right third groove 272C are vented to the atmosphere. Alternatively, for example, the pressure in one or move of these grooves 270A, 270C, 272A, 272C can be precisely controlled.

For example, the first fluid source 276 can include one or more pumps, reservoirs, and/or vacuum pumps. Additionally, the first fluid source 276 can include multiple separate systems. Further, the stiffness of the seal/bearings 278A, 278B can be controlled by controlling the flow of the bearing fluid 280 and the pressure in the fluid inlets. The type of bearing fluid 280 can be varied to suit the design requirements of the apparatus 10. In one embodiment, the bearing fluid 280 is air.

A description of a fluid bearing is described in International Application No. PCT/US00/04223, entitled “STATIC PRESSURE AIR BEARING”, filed Feb. 18, 2000, inventors Watson et al. As far as permitted, the contents of International Application No. PCT/US00/04223 are incorporated herein by reference. Alternately, another vacuum compatible fluid bearing is disclosed in U.S. Pat. No. 6,126,169.

Still alternately, the first subassembly 260 can be used to create only one or more than two seal/bearings 278A, 278B, or the first subassembly 260 can include a magnetic type bearing (riot shown) or a roller bearing type assembly (not shown) could be utilized.

Referring to FIGS. 2C and 2D, the second subassembly 262 selectively seals the connector gap 274 between the seal frame 258 and the mover connector 248, selectively maintains the mover connector 248 a small distance away from the seal frame 258, and/or selectively supports the mover connector 248 and the stage 238 (illustrated in FIG. 2B) relative to the seal frame 258 and the rest of the chamber assembly 242. In one embodiment, the second subassembly 262 inhibits motion of the mover connector 248 relative to the seal frame 258.

The design of the second subassembly 262 can be varied. In one embodiment, the second subassembly 262 includes a left first seal 282A positioned near the connector gap 274, a right second seal 282B positioned near the connector gap 274, and a seal mover 284. In this embodiment, the left first seal 282A is positioned near the left side 264C and the outer environment and the right second seal 282B is positioned near the right side 264D and the controlled environment in the device chamber 252. Alternatively, for example, the seals 282A, 282B can be located elsewhere along the seal frame 246 or the second subassembly 262 can include only one or more than two seals 282A, 282B.

In one embodiment, each seal 282A, 282B is movable by the seal mover 284 between a contracted first configuration 286 (illustrated in FIG. 2C) in which the seals 282A, 282B do not seal the connector gap 274, and an expanded second configuration 288 (illustrated in FIG. 2D) in which the seals 282A, 282B contact the mover connector 248 and seal the connector gap 274.

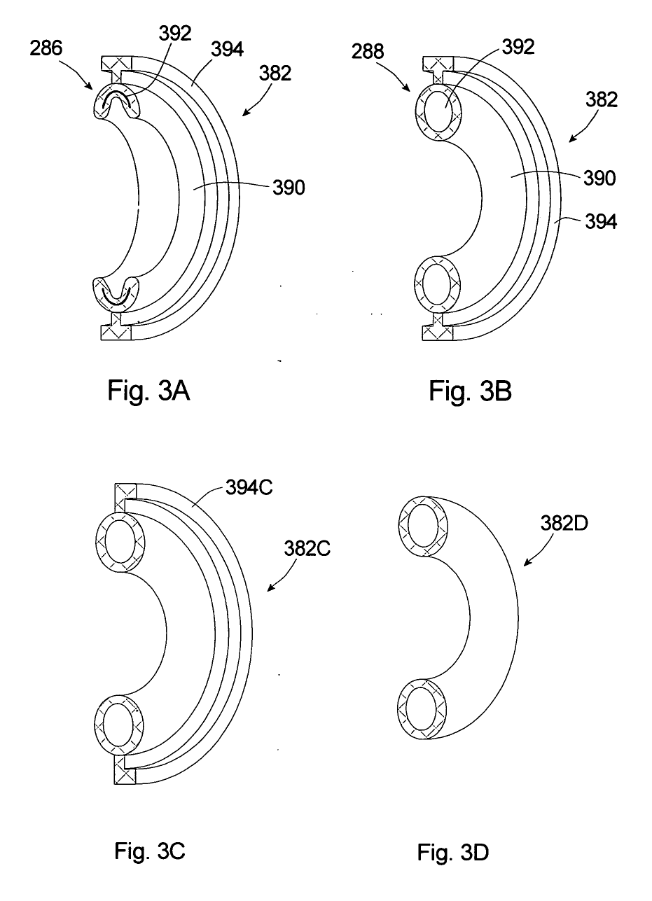

FIG. 3A illustrates a cut-away perspective view of one embodiment of a seal 382 in the first configuration 286 that can be utilized as the first seal 282A or the second seal 282B (illustrated in FIGS. 2C and 2D). FIG. 3B illustrates the seal 382 in the second configuration 288. In this embodiment, the seal 382 includes an annular shaped hollow tube 390, e.g. a hollow “0” ring, that defines a seal cavity 392 and a seal retainer 394 having a “T” shaped cross-section. Alternatively, for example, the tube 390 can be rectangular shaped, hexagonal shaped, or another shape that corresponds to the shape of the mover connector 248 (illustrated in FIG. 2C).

Alternatively, referring to FIG. 3C, the seal retainer 394C of the seal 382C can be another shape, e.g. “L” shaped or referring to FIG. 3D, the seal 382D does not include the seal retainer.

Referring back to FIGS. 2C and 2D, in this embodiment, the seal retainer 394 of the first seal 282A engages a portion of the first channel 266A to retain the first seal 282A in the seal frame 238, and the seal retainer 394 of the second seal 282B engages a portion of the second channel 266B to retain the second seal 282B in the seal frame 258.

In one embodiment, the seal mover 284 moves at least one of the seals 282A, 282B between the configurations 286, 288. For example, the seal mover 284 can alter the shape of the seals 282A, 282B so that in the first configuration 286 the seals 282A, 282B do not engage the mover connector 248 and in the second configuration 288 the seals 282A, 282B engage the mover connector 248.

In one embodiment, at least one of the seals 282A, 282B is formed so that the seal 282A, 282B is naturally biased to return to or stay in the first configuration 286. In this embodiment, the seal mover 284 can direct a seal fluid 295 into the seal cavity 392 of each seal 282A, 282B to move each seal 282A, 282B from the first configuration 286 to the second configuration 288. The rate at which the seal fluid 295 is pumped into the seal cavity 392 can vary. For example, the seal fluid 295 can be supplied to the seal cavity 392 at a rate which quickly moves each seal 282A, 282B to the second configuration 288.

Alternatively, for example, at least one of the seals 282A, 282B is formed so that the seal 282A, 282B is naturally biased to return to or stay in the second configuration 288. In this embodiment, the seal mover 284 can remove the seal fluid 295 from the seal cavity 392 of each seal 282A, 282B to move each seal 282A, 282B from the second configuration 288 to the first configuration 286. In this embodiment, the seal mover 284 can direct the seal fluid 295 into the seal cavity 392 or allow the seal cavity 392 to be open to the environment.

For example, the seal mover 284 can include one or more pumps, reservoirs, motors, and/or vacuum pumps. Additionally, the seal mover 284 can include multiple separate systems.

In one embodiment, (i) the first subassembly 260 seals the connector gap 274 between the seal frame 258 and the mover connector 248, and supports the mover connector 248 relative to the seal frame 258 during normal operation of the exposure apparatus 10 (illustrated in FIG. 1), and (ii) the second subassembly 262 seals the connector gap 274 between the seal frame 258 and the mover connector 248, supports the mover connector 248 relative to the seal frame 258 in the event the first subassembly 260 fails or is not in operation. In this embodiment, the first subassembly 260 functions as a primary subassembly because it is the primary seal and bearing for the connector gap 274, and the second subassembly 262 functions as a secondary or backup subassembly because it is the backup seal for the connector gap 274. With this design, the second subassembly 262 can maintain the controlled environment in the chamber assembly 242 until the first subassembly 260 is repaired or back in operation. This can reduce the down time of the exposure apparatus 10.

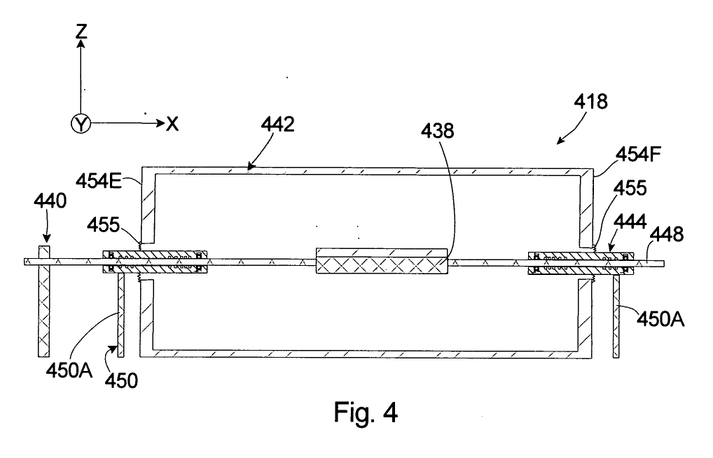

FIG. 4 is a perspective view of a portion of another embodiment of a stage assembly 418 that can be used in the exposure apparatus 10 FIG. 1. In this embodiment, the stage assembly 418 includes a stage 438, a stage mover assembly 440 and a chamber assembly 442 that are somewhat similar to the corresponding components described above. However, in this embodiment, the each seal assembly 444 is secured and sealed to one of the frame walls 454E, 454F with a mechanical bellow 455 that allows for motion of the seal assembly 444 relative to the frame walls 454E, 454F. Alternatively, for example, another type of seal can be used to seal each seal assembly 444 to one of the frame walls 454E, 454F that allows for motion of the seal assembly 444 relative to the frame walls 454E, 454F.

Moreover, in this embodiment, the mover assembly 450 includes a mover 450A that moves each of the seal assemblies 444. With this design, the mover assembly 450 can be designed to adjust the position of the mover connector 448 and the stage 438 with up to six degrees of freedom.

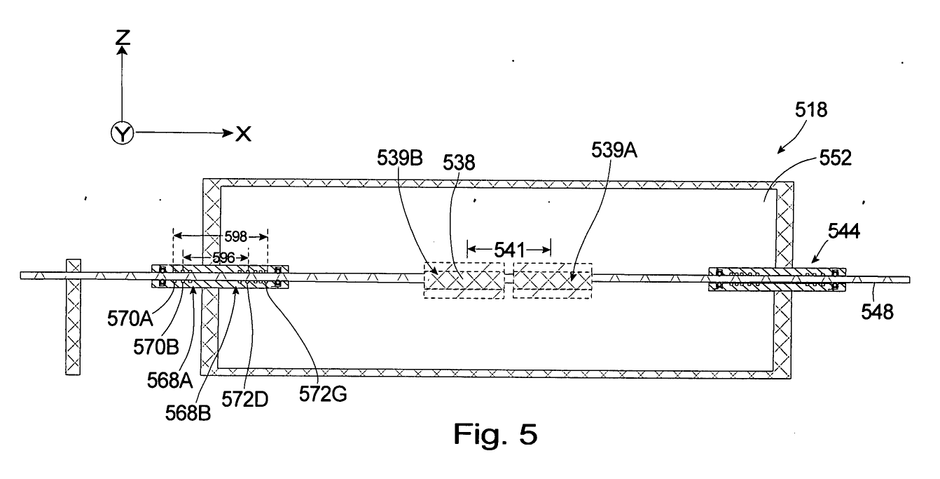

FIG. 5 is a cut-away view of a portion of the stage assembly 518 with a stage 538 (in phantom) in a first stage position 539A and in a second stage position 539B. In this embodiment, (i) in the first stage position 539A, the stage 538 is at the rightmost position along the X axis during device processing; (ii) in the second stage position 539B, the stage 538 is at the leftmost position along the X axis during device processing; and (iii) the stage 538 is moved a stage travel distance 541 between the positions 539A, 539B along the X axis. In alternative, non-exclusive embodiments, the stage travel distance 541 is approximately 150, 200, 300, 400, or 500 mm.

FIG. 5 also illustrates that for each seal assembly 544, that an outlet distance 596 separates the left second groove 570B (the first fluid outlet) of the first groove set 568A and the right fourth groove 572D (the second fluid outlet) of the second groove set 568B. In alternative, non-exclusive embodiments, the outlet distance 596 is approximately 150, 200, 300, 400, or 500 mm.

FIG. 5 also illustrates that for each seal assembly 544, that an inlet distance 598 separates the left first groove 570A (the outermost fluid inlet) of the first groove set 568A and the right seventh groove 572G (the innermost fluid inlet) of the second groove set 568B. In alternative, non-exclusive embodiments, the inlet distance 598 is approximately 150, 200, 300, 400, or 500 mm.

In one embodiment, the inlet distance 598 is greater than the stage travel distance 541. In another embodiment, the outlet distance 596 is also greater than the stage travel distance 541. With this design, the portion of the mover connector 548 that is positioned in the chamber 552 is never exposed to the outside environment. This inhibits surfaces exposed to the outside atmosphere from carrying contaminants directly into the chamber 552.

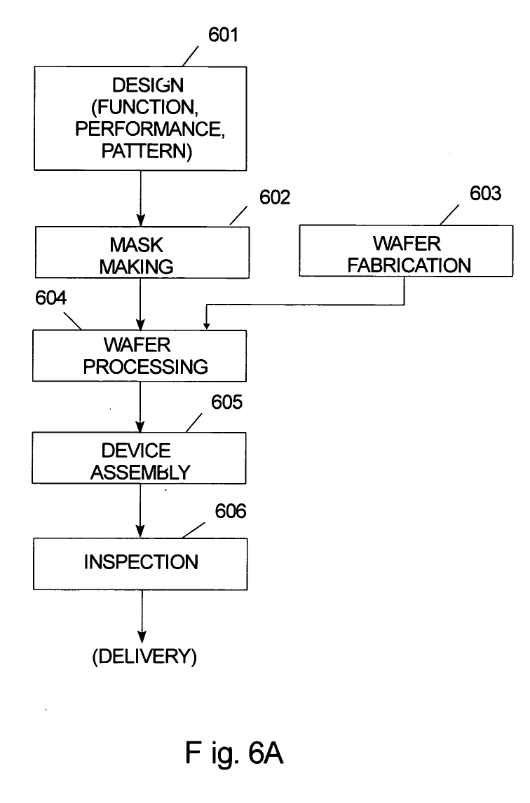

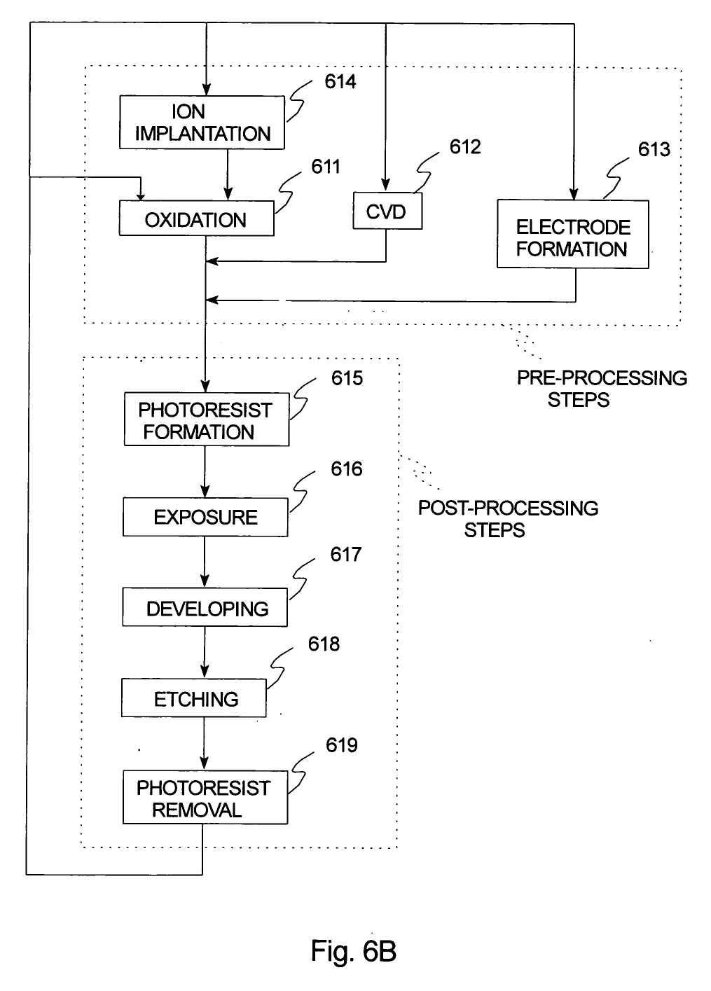

Semiconductor devices can be fabricated using the above described systems, by the process shown generally in FIG. 6A. In step 601 the device's function and performance characteristics are designed. Next, in step 602, a mask (reticle) having a pattern is designed according to the previous designing step, and in a parallel step 603 a wafer is made from a silicon material. The mask pattern designed in step 602 is exposed onto the wafer from step 603 in step 604 by a photolithography system described hereinabove in accordance with the present invention. In step 605 the semiconductor device is assembled (including the dicing process, bonding process and packaging process), finally, the device is then inspected in step 606.

FIG. 6B illustrates a detailed flowchart example of the above-mentioned step 604 in the case of fabricating semiconductor devices. In FIG. 6B, in step 611 (oxidation step), the wafer surface is oxidized. In step 612 (CVD step), an insulation film is formed on the wafer surface. In step 613 (electrode formation step), electrodes are formed on the wafer by vapor deposition. In step 614 (ion implantation step), ions are implanted in the wafer. The above mentioned steps 611-614 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 615 (photoresist formation step), photoresist is applied to a wafer. Next, in step 616 (exposure step), the above-mentioned exposure device is used to transfer the circuit pattern of a mask (reticle) to a wafer. Then in step 617 (developing step), the exposed wafer is developed, and in step 618 (etching step), parts other than residual photoresist (exposed material surface) are removed by etching. In step 619 (photoresist removal step), unnecessary photoresist remaining after etching is removed.

Multiple circuit patterns are formed by repetition of these preprocessing and post-processing steps.

While the particular exposure apparatus 10 as shown and disclosed herein is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A seal assembly for sealing a connector gap between a connector and a frame, the seal assembly comprising:
a first subassembly that seals the connector gap; and
a second subassembly that selectively seals the connector gap.

2. The seal assembly of claim 1 wherein the second subassembly includes a seal that is movable between a first configuration in which the seal does not seal the connector gap and a second configuration in which the seal does seal the connector gap.

3. The seal assembly of claim 2 wherein the seal defines a seal cavity.

4. The seal assembly of claim 2 wherein the second subassembly includes a seal mover that moves the seal between the first configuration and the second configuration.

5. The seal assembly of claim 4 wherein the seal mover directs a fluid into the seal to move the seal from the first configuration to the second configuration.

6. The seal assembly of claim 4 wherein the seal mover removes a fluid from the seal to move the seal from the second configuration to the first configuration.

7. The seal assembly of claim 1 wherein the first subassembly creates a fluid type bearing in the connector gap that allows the connector to move relative to the frame.

8. The seal assembly of claim 1 wherein the first subassembly creates a vacuum compatible fluid type bearing in the connector gap that allows the connector to move relative to the frame.

9. The seal assembly of claim 1 wherein the second subassembly seals the connector gap in the event the first subassembly does not seal the connector gap.

10. A chamber assembly that encircles a device, the chamber assembly comprising a wall and the seal assembly of claim 1.

11. A stage assembly for moving a device, the stage assembly comprising (i) a stage that retains the device, (ii) a stage mover assembly that includes a connector that is coupled to the stage and a mover assembly that moves the connector and the stage, and (iii) a chamber assembly that encircles the stage, the chamber assembly including the seal assembly of claim 1.

12. An exposure apparatus for transferring an image to a device, the exposure apparatus comprising: the stage assembly of claim 11 moving the device, and an environmental system that controls an environment in the chamber assembly.

13. A stage assembly for moving a device, the stage assembly comprising:
a stage that retains the device;
a stage mover assembly that moves the stage, the stage mover assembly including a connector that is coupled to the stage and a mover assembly that moves the connector and the stage; and
a chamber assembly that encircles the stage, the chamber assembly including a frame having an aperture for receiving a portion of the connector, and a seal that is selectively movable between a first configuration in which the seal does not seal a connector gap between the frame and the connector and a second configuration in which the seal does seal the connector gap.

14. The stage assembly of claim 13 wherein the seal defines a seal cavity.

15. The stage assembly of claim 13 wherein the chamber assembly includes a seal mover that moves the seal between the first configuration and the second configuration.

16. The stage assembly of claim 15 wherein the seal mover directs a fluid into the seal to move the seal from the first configuration to the second configuration.

17. The stage assembly of claim 15 wherein the seal mover removes a fluid from the seal to move the seal from the second configuration to the first configuration.

18. The stage assembly of claim 13 wherein the chamber assembly includes a first subassembly that seals the connector gap.

19. The stage assembly of claim 18 wherein the first subassembly creates a fluid type bearing in the connector gap that allows the connector to move relative to the frame.

20. The stage assembly of claim 18 wherein the first subassembly creates a vacuum compatible fluid type bearing in the connector gap that allows the connector to move relative to the frame.

21. The stage assembly of claim 18 wherein the seal seals the connector gap in the event the first subassembly does not seal the connector gap.

22. The stage assembly of claim 18 wherein the mover assembly moves the stage a stage travel distance between a first stage position and a second stage position; and wherein the first subassembly defines a first seal/bearing having a first fluid outlet and a second seal/bearing having a second fluid outlet, and wherein the first fluid outlet is spaced apart from the second fluid outlet an outlet distance that is greater than the stage travel distance.

23. An exposure apparatus for transferring an image to a device, the exposure apparatus comprising: the stage assembly of claim 13 moving the device, and an environmental system that controls an environment in the chamber assembly.

24. A stage assembly for moving a device, the stage assembly comprising:
a stage that retains the device;
a stage mover assembly that moves the stage, the stage mover assembly including a connector that is coupled to the stage and a mover assembly that moves the connector and the stage, the stage being movable a stage travel distance between a first stage position and a second stage position; and
a chamber assembly that encircles the stage, the chamber assembly including a frame having an aperture for receiving a portion of the connector, a first seal/bearing having a first fluid outlet, and a second seal/bearing having a second fluid outlet, the seal/bearings cooperating to seal the frame to the connector, wherein the first fluid outlet is spaced apart from the second fluid outlet an outlet distance that is greater than the stage travel distance.

25. The stage assembly of claim 24 wherein the first seal/bearing includes an outermost fluid inlet and the second seal/bearing includes an innermost fluid inlet and wherein the outermost fluid inlet is spaced apart from the innermost fluid inlet an inlet distance that is greater than the stage travel distance.

26. A method for sealing a connector gap between a connector and a frame, the method comprising the steps of:
sealing the connector gap with a first subassembly; and
selectively sealing the connector gap with a second subassembly.

27. The method of claim 26 wherein the step of selectively sealing includes the step of moving a seal between a first configuration in which the seal does not seal the connector gap and a second configuration in which the seal does seal the connector gap.

28. The method of claim 27 wherein the step of moving includes the step of directing a fluid into the seal to move the seal from the first configuration to the second configuration.

29. The method of claim 27 wherein the step of moving includes the step of removing a fluid from the seal to move the seal from the second configuration to the first configuration.

30. The method of claim 26 wherein the step of sealing includes creating a fluid type bearing in the connector gap that allows the connector to move relative to the frame.

31. A method for making a stage assembly for moving a device, the method comprising the steps of: (i) retaining the device with a stage, (ii) coupling a connector to the stage, (iii) moving the connector and the stage with a mover assembly, (iv) encircling the stage with a chamber assembly including a frame, and (v) sealing a connector gap between the frame and the connector by the method of claim 26.

32. A method for making an exposure apparatus for transferring an image to a device, the method comprising the steps of providing an optical assembly, and moving the device with a stage assembly made by the method of claim 31.

33. A method for moving a device, the method comprising the steps of:
retaining the device with a stage;
coupling a connector to the stage;
moving the connector and the stage with a mover assembly; and
encircling the stage with a chamber assembly, the chamber assembly including a frame having an aperture for receiving a portion of the connector, and a seal that is selectively movable between a first configuration in which the seal does not seal a connector gap between the frame and the connector and a second configuration in which the seal does seal the connector gap.

34. The method of claim 33 wherein a fluid is directed into the seal to move the seal from the first configuration to the second configuration.

35. The method of claim 33 wherein a fluid is removed from the seal to move the seal from the second configuration to the first configuration.

36. The method of claim 33 further comprising the step of sealing the connector gap with a first subassembly.

37. A method for making an exposure apparatus for transferring an image to a device, the method comprising the steps of providing an optical assembly, and moving the device by the method of claim 33.
